(19) United States
(12) Patent Application Publication
(10) Pub. No.: US 2014/0298788 A1
(43) Pub. Date: Oct. 9, 2014

(54) GAS TURBINE ENGINE INCLUDING PNEUMATIC ACTUATOR SYSTEM

(71) Applicant: United Technologies Corporation, Hartford, CT (US)

(72) Inventors: Ken F. Blaney, Middleton, NH (US); Richard K. Hayford, Cape Neddick, ME (US)

(73) Assignee: United Technologies Corporation, Hartford, CT (US)

(21) Appl. No.: 14/174,537

(22) Filed: Feb. 6, 2014

Related U.S. Application Data
(60) Provisional application No. 61/809,657, filed on Apr. 8, 2013.

(51) Int. Cl. F02C 1/02

(52) U.S. Cl. CPC F02C 1/02
USPC 60/407

(57) ABSTRACT

A gas turbine engine that includes a compressor section and a pneumatic actuator system is delivered. The pneumatic actuator system includes a bleed air duct that receives bleed air from the compressor section and delivers the bleed air through an accumulator and to an actuator. The accumulator includes a chamber that attenuates a fluctuation in a pressure of the bleed air.

This application claims priority to U.S. Patent Appln. No. 61/809,657 filed Apr. 8, 2013.

Aspects of the present invention were made with Government support under Contract No. FA8650-09-D-2923 0021 awarded by the Department of the Air Force. The Government has certain rights to aspects of the present invention.

### BACKGROUND

1. Technical Field

Aspects of the present invention generally relate to gas turbine engines, and more particularly relate to gas turbine engines that include pneumatic actuator systems.

2. Background Information

Some gas turbine engines include a compressor section and an actuator that receives bleed air from the compressor section. In such gas turbine engines, the pressure of the bleed air can undesirably fluctuate. Aspects of the present invention are directed to this and other problems.

### SUMMARY

According to an aspect of the present invention, a gas turbine engine that includes a compressor section and a pneumatic actuator system is provided. The pneumatic actuator system includes a bleed air duct that receives bleed air from the compressor section and delivers the bleed air through an accumulator and to an actuator. The accumulator includes a chamber that attenuates a fluctuation in a pressure of the bleed air.

According to another aspect of the present invention, a pneumatic actuator system for use with a gas turbine engine is provided. The pneumatic actuator system includes a bleed air duct, an accumulator, and an actuator. The bleed air duct receives bleed air from a compressor section of the gas turbine engine and delivers the bleed air through the accumulator and to the actuator. The accumulator includes a chamber that attenuates a fluctuation in a pressure of the bleed air.

These and other aspects of the present invention will become apparent in light of the drawing and detailed description provided below.

### BRIEF DESCRIPTION OF THE DRAWING

FIG. 1 is diagrammatic sectional illustration of a gas turbine engine.

### DETAILED DESCRIPTION

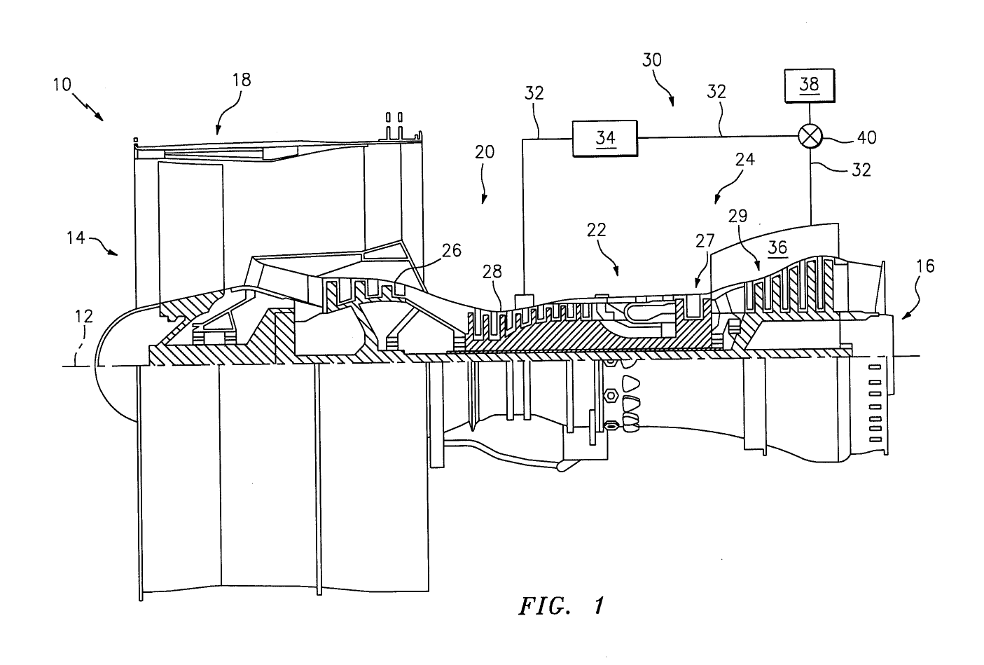

The present disclosure describes embodiments of a gas turbine engine 10, and systems and components thereof. Referring to the embodiment illustrated in FIG. 1, the engine 10 extends along an axial centerline 12 between an upstream inlet section 14 and a downstream exhaust section 16. The engine 10 includes a fan section 18, a compressor section 20, a combustor section 22, and a turbine section 24 arranged sequentially along the centerline 12. The compressor section 20 includes a low pressure compressor (“LPC”) 26 and a high pressure compressor (“HPC”) 28. The turbine section 24 includes a high pressure turbine (“HPT”) 27 and a low pressure turbine (“LPT”) 29. In some embodiments, the engine 10 may additionally include an augmentor section (not shown). Aspects of the present invention are not limited to use with the engine 10 embodiment illustrated in FIG. 1. For example, although the engine 10 embodiment in FIG. 1 is depicted as being a two-spool turbo fan, aspects of the present invention may also be applied to other types of gas turbine engines.

The engine 10 also includes a pneumatic actuator system 30 that includes a bleed air duct 32, an accumulator 34, and an actuator 36. In some embodiments, including the embodiment illustrated in FIG. 1, the pneumatic actuator system 30 may additionally include a controller 38, and/or a valve 40.

The bleed air duct 32 receives bleed air from the compressor section 20 (e.g., from the LPC 26 and/or the HPC 28) and delivers the bleed air through the accumulator 34 and to the actuator 36. The engine 10 is not limited to use with a bleed air duct 32 having any particular structure. In some embodiments, the bleed air duct 32 may include an inlet port, an outlet port, and a passageway extending there between. In such embodiments, the inlet port of the bleed air duct 32 may be fluidly connected (e.g., directly or indirectly) to the compressor section 20, and the outlet port of the bleed air duct 32 may be fluidly connected (e.g., directly or indirectly) to the actuator 36.

The accumulator 34 is fluidly connected to the bleed air duct 32 and is fluidly disposed between the compressor section 20 and the actuator 36. The accumulator 34 includes an internal chamber that receives bleed air from the bleed air duct 32. The chamber has a volume that may be fixed or variable. The volume of the chamber may generally be in the range of approximately two and eight tenths (2.8) liters and twenty eight (28) liters (i.e., in the range of approximately one tenth (0.1) of a cubic foot and one (1) cubic foot). One of ordinary skill in the art will appreciate that the volume of the chamber of the accumulator 34 may depend, for example, on a characteristic of the bleed air duct 32 (e.g., a volume of the bleed air duct 32), or a characteristic of the actuator 36 (e.g., a volume of the actuator 36). The chamber attenuates fluctuations in the pressure of the bleed air. With the accumulator 34 excluded from the pneumatic actuator system 30, the fluctuations in the pressure of the bleed air received by the actuator 36 may be as high as approximately seven (7) MPa gauge (i.e., approximately one thousand (1,000) psi gauge). With the accumulator 34 included in the pneumatic actuator system 30, the fluctuations in the pressure of the bleed air received by the actuator 36 may be attenuated so that they are no higher than, for example, approximately 700 kPa gauge (i.e., approximately one hundred (100) psi gauge). One of ordinary skill in the art will appreciate that the volume of the chamber of the accumulator 34 will determine the amount of attenuation. Although the bleed air duct 32 and the accumulator 34 are described herein as discrete components that are fluidly connected to one another, it is contemplated that the bleed air duct 32 and the accumulator 34 may alternatively be one unitary piece; e.g., the accumulator 34 may be a bulbous region of the bleed air duct 32.

The actuator 36 is fluidly connected to the bleed air duct 32 and receives bleed air from the bleed air duct 32. The engine 10 is not limited to use with any particular actuator 36. In some embodiments, for example, the actuator 36 may include a piston, and the actuator 36 may convert energy in the bleed air into mechanical motion of the piston. In some embodiments, the actuator 36 may be used to adjust the positioning of a component in the turbine section 24 of the engine 10; e.g., in the HPT 27 and/or the LPT 29. In the embodiment illustrated in FIG. 1, the actuator 36 is used to adjust a radial position of a blade outer air seal (BOAS) in both the HPT 27 and the LPT 29. In other embodiments, the actuator 36 may be used to adjust a component (e.g., a nozzle) in the exhaust section 16 of the engine 10.

During operation of the engine 10, the bleed air is selectively delivered to the actuator 36 via the bleed air duct 32. In the embodiment illustrated in FIG. 1, the pneumatic actuator system 30 includes a valve 40 that is fluidly connected to the bleed air duct 32 and is fluidly disposed between the accumulator 34 and the actuator 36. The valve 40 is selectively actuatable between an open position and a closed position (e.g., by the controller 38) to control the delivery of the bleed air to the actuator 36. Although the valve 40 is shown in FIG. 1 as being fluidly disposed between the accumulator 34 and the actuator 36, in other embodiments the valve 40 may be fluidly disposed between the compressor section 20 and the accumulator 34. When the bleed air is received by the actuator 36, it converts energy in the bleed air into mechanical motion.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A gas turbine engine, comprising:
a compressor section; and
a pneumatic actuator system that includes a bleed air duct that receives bleed air from the compressor section and delivers the bleed air through an accumulator and to an actuator;
wherein the accumulator includes a chamber that attenuates a fluctuation in a pressure of the bleed air.

2. The gas turbine engine of claim 1, wherein the compressor section includes a low pressure compressor and a high pressure compressor.

3. The gas turbine engine of claim 2, wherein the bleed air duct receives bleed air from the high pressure compressor.

4. The gas turbine engine of claim 1, wherein the bleed air duct includes an inlet, an outlet, and a passageway extending there between.

5. The gas turbine engine of claim 1, wherein the inlet of the bleed air duct is fluidly connected to the compressor section, and the outlet of the bleed air duct is fluidly connected to the actuator.

6. The gas turbine engine of claim 1, wherein the accumulator is fluidly connected to the bleed air duct and is fluidly disposed between the high pressure compressor and the actuator.

7. The gas turbine engine of claim 1, wherein the chamber has a volume within the range of 2.8 liters and 28 liters.

8. A pneumatic actuator system for use with a gas turbine engine, comprising:
a bleed air duct;
an accumulator; and
an actuator;
wherein the bleed air duct receives bleed air from a compressor section of the gas turbine engine and delivers the bleed air through the accumulator and to the actuator;
wherein the accumulator includes a chamber that attenuates a fluctuation in a pressure of the bleed air.
